(19) United States
(12) Patent Application Publication
(10) Pub. No.: US 2020/0009847 A1
(43) Pub. Date: Jan. 9, 2020

(54) PLANT AND PROCESS FOR THE PRODUCTION OF PAPER LOGS

(71) Applicant: FUTURA S.P.A., Capannori (IT)

(72) Inventors: Fabio PERINI, Viareggio (IT); Giovacchino GIURLANI, Capannori (IT); Andrea CATALINI, Porcari (IT)

(73) Assignee: FUTURA S.P.A., Capannori (IT)

(21) Appl. No.: 16/468,176

(22) PCT Filed: Dec. 1, 2017
(86) PCT No.: PCT/IT2017/000273

§ 371 Date: Jun. 10, 2019

(30) Foreign Application Priority Data
Dec. 16, 2016 (IT) 102016000127319

(51) Int. Cl. B32B 37/20; B65H 16/02; B65H 20/02; B32B 1/08; B32B 3/30; B32B 29/00; B32B 38/06

(52) U.S. Cl. CPC B32B 37/20; B65H 16/02; B65H 20/02; B32B 1/08; B65H 2701/71; B32B 29/005; B32B 38/06; B65H 2301/522; B65H 2404/143; B32B 3/30

(57) ABSTRACT

Plant for the production of paper logs, including at least one unwinder that supports a reel from which corresponding ply of paper unwounds, at least one processing unit that is supplied with the ply and is configured to modify the structure or conformation of the same ply, guiding means for guiding the ply arranged along a predetermined path between the at least one unwinder and the processing unit. The guide means are configured to provide a nip traversed by the ply at a preliminary stage of drawing-in of the ply, the nip being subsequently eliminated when the step of drawing-in is completed.

The present invention relates to a process and a plant for the production of paper logs.

It is known that the production of paper-based logs, from which, for example, are obtained toilet paper rolls or kitchen paper rolls, implies feeding a paper web, consisting of one or more superimposed plies, on a predetermined path along which several operations are performed prior to make the logs, including a transverse web pre-engraving to form pre-cut lines that divide it into separable tear-off sheets. The formation of logs involves the use of cardboard tubes, commonly known as “cores” on whose surface is distributed a predetermined amount of glue to allow the bonding of the paper web on the cores introduced into the machine that produces the paper logs, commonly called “rewinder”. The glue is distributed on the cores when they pass along a corresponding path comprising an end portion commonly called “cradle” due to its concave shape. The formation of the logs also implies the use of winding rollers placed at the cradle, which provoke the rotation of each core about its longitudinal axis thereby causing the winding of the web on the cores. One of said rollers is positioned lower than the cradle while other rollers are placed above the cradle. The process ends when a predetermined number of sheets is wrapped around the core and the last sheet is glued on the underlying paper of the log (so-called “flap closure” operation). Upon reaching the predetermined number of sheets wrapped around the core, the last sheet of the log being completed is separated from the first sheet of the next log, for example by means of a compressed air jet directed to a corresponding pre-cut line. At this point, the log is discharged from the rewinder. EP1700805 discloses a rewinder machine that operates as disclosed above.

At a preliminary stage of the process, the paper web, that is fed by reels placed on respective unwinders, is carried in almost manual mode up to the rewinder station that houses the winding rollers. In practice, an operator engages a flap of the paper web to a drawing-in belt that follows a path at a side of the path that will be followed by the web during the production of the logs. Subsequently, the operator, by operating the system at reduced speed or in a jog mode, ensures that the paper web passes between the components of the plant until it reaches the guide, pre-engraving and winding rollers of the rewinder. Once this step has been completed, with a knife the operator releases said flap from the drawing-in belt and removes the excess paper. At this point, the operator starts the production of the logs in the automatic mode.

Along the path downstream of the unwinder, during the drawing-in step the paper is subjected to tensions which may cause it to break or release from the drawing-in belt. In such a case, the operator is obliged to repeat the entire procedure with self-evident production drawbacks.

The main purpose of the present invention is to eliminate or at least reduce the aforesaid drawbacks.

This result has been achieved, in accordance with the present invention, by adopting the idea of implementing an operating method and implementing a plant having the features indicated in the independent claims. Other features of the present invention are the subject of the dependent claims.

Thanks to the present invention, it is possible to eliminate or significantly reduce the risk of breaking the paper web during the drawing-in step. At the same time, the drawing-in operation is simplified. Further advantages derive from the relative constructive and functional simplicity of the mechanism that makes the drawing-in step more reliable, and also allows a reduction of the total time required to make the drawing-in as this operation can be speeded up. In fact, since the paper web is subject to reduced tensions, it is possible to increase the speed of the drawing-in step.

These and further advantages and features of the present invention will be better understood by the following description and the accompanying drawings, provided by way of example but not to be considered in a limitative sense, in which:

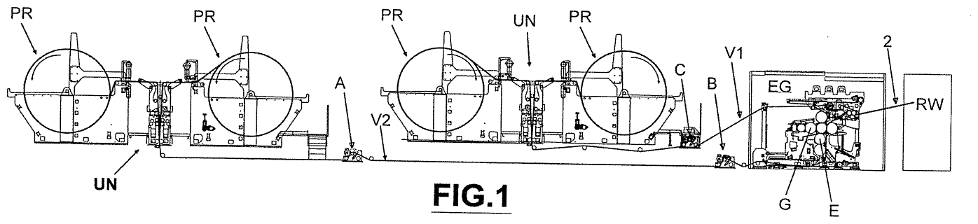

FIG. 1 is a schematic side view of a plant for the production of paper logs having a mechanism for implementing a process in accordance with the present invention;

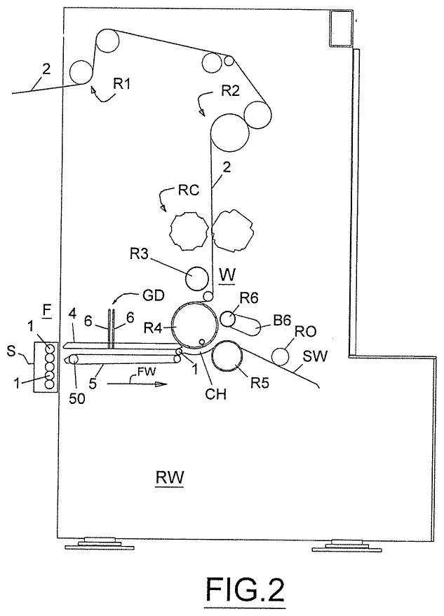

FIG. 2 is a schematic but detailed representation of the rewinder (RW) shown in FIG. 1;

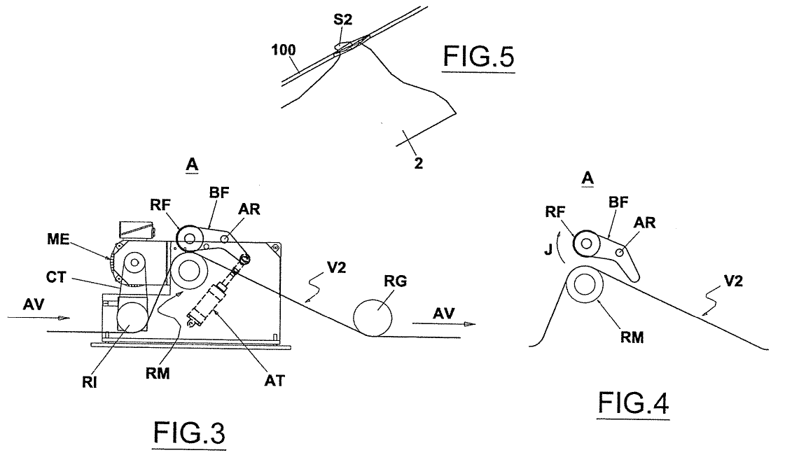

FIG. 3 is an enlarged detail of FIG. 1;

FIG. 4 is a simplified representation of the group of FIG. 3 in a different operating position;

FIG. 5 schematically represents a paper web hooked to a drawing-in belt.

A plant according to the present invention comprises a rewinder (RW) that, with particular reference to the example shown in FIG. 2, is of the type comprising:
a cores feeding station (F) for feeding the cores (1) coming from a cores store (S) where a feeder (not visible in the drawings) is provided for sequentially collect a core (1) and feeding it to a guide where a gluing device (GD), further disclosed below, is provided;
means for feeding a paper web (2) made of one or more paper plies and for providing it with transverse pre-cut lines, with a plurality of guide rollers (R1, R2) and cutting rollers (RC) arranged along a predetermined web feeding and pre-cutting path;
means for winding the paper web (2) on a core (1) in a winding station (W), with a first winding roller (R4) located downstream of said guide and cutting rollers (R1, R2, R3, RC), and two further rollers (R5, R6) arranged downstream of the first winding roller (R4) with respect to the direction followed by the cores (1) and the paper web (2): the second and the third winding roll (R5, R6) being disposed downstream of a curved guide that, in cooperation with the first winding roller (R4), delimits a channel (CH) downstream of the glueing (GD), said channel being sequentially crossed by the cores (1) on which the glueing device (GD) distributes a predetermined amount of glue.

The first winding roller (R4) has also the function of guiding the paper web (2) coming from the guide and cutting rollers positioned upstream. The second roller (R5) is below the third roller (R6) of the winding station (W).

The third winding roller (R6) is mounted on the end of an arm (B6) connected to a respective actuator which allows it to approach the said channel and respectively to move it away in relation the instantaneous diameter of the log being formed.

In said winding station (W) there is a chute (SW) on which the paper logs can roll once they are completed and are released by the roller (R6). The system formed by the winding rollers (R4, R5, R6), the respective actuators and the control unit of such actuators are known. Also known are the ways of removing a completed log (RO) from the station (W) and how to start the formation of a new log in the same station (W). The channel (CH) delimits the last track of the path followed by the paper web (2) and the cores (1) before entering the winding station (W).

A preset amount of glue is applied to the cores (1) to allow the bonding of the paper web (2) to the same cores (1), in a known manner, while the same cores (1) advance along a predetermined direction (FW) defined by the guide served by the feeder (RF), to reach the station (W) where the logs are formed. For example, said guide is formed by several motorized belts (5) that are guided over pulleys (50) whose axes are horizontal and orthogonal to said advancing direction (FW) and by a corresponding set of fixed plates (4) having a prevailing longitudinal development (length higher than height and thickness). The motorized belts (5) engage the cores coming from the cores feeding station (F) and oblige them to rotate and translate upstream of the channel (CH).

The glueing device (GD) comprises two glue dispensing units (6) placed sequentially between the plates (4). The glue dispensing units (6) distribute the glue, from the above, to the cores (1) along the path imposed by said guide (4, 5). Therefore, on each of the cores (1) passing through the guide (4, 5), a given amount of glue is applied at two separate points, which, as known, serve to bond the last sheet of a log formed in the station winding (W) with the underlying sheet of the same log and respectively to bond the first sheet of a new log to a corresponding core (1). Such a process of applying glue to the cores (1) is in itself known.

The plant further comprises a drawing-in mechanism for threading the paper web (2) in a preparation step preceding the production of the paper logs. The drawing-in mechanism comprises a drawing-in belt (100) provided along a predetermined path on at least one side of the plant, the drawing-in belt allowing the paper web (2) to be passed between the units of the plant up to the rewinder (RW). For example, the drawing-in belt (100) is of the type disclosed in EP2909120B1. The engagement/disengagement of a flap or edge (S2) of the paper web to/from the drawing-in belt (100) are known operations.

According to the example shown in FIG. 1, the plies (V1, V2) of the paper web (2) are fed by parent reels (PR) positioned on corresponding unwinders (UN). Downstream of the unwinders (UN) there is a gluing and embossing unit (EG) where the plies (V1, V2) are embossed and bonded to form the web (2) that feeds the rewinder (RW) located downstream of the unit (EG) with respect to the direction followed by the plies (V1, V2). It is understood that the plies (V1, V2), or a single ply if the web (2) is made by a single ply, could only be embossed. In this case, the unit (EG) would not have glueing means or the latter, if present, could be deactivated. In the example shown in FIG. 1, the glueing means that provide the glue for joining the plies (V1, V2) are denoted by the reference “G” while the embossing rollers are marked by reference “E”. Alternatively, between the unwinders (UN) and the gluing and embossing unit unit (EG) could be inserted into a printing unit, known per se.

At one or more predetermined points (A, B, C) of the path followed by each ply (V1, V2) downstream of the unwinders (UN), a motorized roller (RM) is provided over which the plies (V1, V2) move. The roller (RM) is connected to an electric motor (ME) which controls its rotation at a predetermined speed (clockwise with reference to FIG. 3) in a direction corresponding to the advancement (AV) of the ply. Above the motorized roller (RM) is placed an idle roller (RF) mounted on an arm (BF) hinged on a respective rotation axis (AR) and, on the opposite side, is connected to an actuator (AT) supported by a fixed structure (SA) that also supports the motor (ME) and the motorized roller (RM). Therefore, the idle roller (RF) can be moved towards the driven roller (RM) and moved away from the latter, while the ply (V1, V2) advances along the advancement direction (AV). According to the example shown in FIG. 3, the ply (V2) is driven, when entering the point (A), by an input roller (IR) connected to the motor (ME) by means of a transmission belt (CT). At exit from point (A), i.e. downstream of the motorized or driven roller (RM), a further guide roller (RG) for the ply (V2) is provided. In FIG. 3 the roller (RF) is close to the roller (RM) while the ply (V2) passes along the advancement direction (AV). In FIG. 4, where the arrow “J” represents the movement of the (BF) rotating clockwise around the axis (AR), the roller (RF) is spaced from the roller (RM).

Advantageously, during said drawing-in step, the roller (RF) is moved against the roller (RM). Subsequently, i.e. when the logs are produced in the rewinder (RW), the roller (RF) can be distanced from the roller (RM) to avoid the risk that the paper forming the logs will be damaged due to its passage through the nip that is formed when the roller (RF) is moved against the roller (RM). The roller (RM), however, continues to rotate thus favoring the transit of the respective ply (V1; V2).

As mentioned above, the unit formed by the motorized roller (RM) and the idle roller (RF) can be provided at several points (A, B, C) of the path followed by the plies (V1, V2). In particular, said points (A, B, C) are points comprised between the unwinders (UN) and the embossing unit (EG). The presence of said units allows the drawing-in operation to be carried out at a higher speed than normal since, when in the roller (RF) is against the roller (RM), the ply (V1, V2) passing through said nip is subject to lower stress.

According to the description provided above, a plant for the production of paper logs according to the present invention comprises:
at least one unwinder (A) that supports a reel (PR) from which a corresponding ply (V1; V2) of paper unwounds,
at least one processing unit (EG; RW) that is supplied with said ply (V1; V2) and is configured to modify the structure or the shape of the same ply,
guiding means for guiding said ply (V1; V2) arranged along a predetermined path between the at least one unwinder (A) and the processing unit (EG; RW), wherein
said guide means are configured to provide a nip traversed by said ply (V1; V2) at a preliminary stage of drawing-in of the ply, said nip being subsequently eliminated when said drawing-in step is completed.

According to the example provided above, said processing unit is an embossing unit (EG) that, in turn, supplies a rewinder (RW); and said means for guiding the plies (V1, V2) are provided at points (A, B, C) located upstream of the embossing unit. The embossing unit (EG) is a machine that modifies the structure of at least one one of the plies (V1, V2) since, when exiting such machines, at least one of the plies is embossed. The rewinder (RW) is a machine that modifies the shape of the ply or plies (V1, V2) since, when they exit from such a machine, theu are wound on a cardboard core thus forming a paper log. The axes of the rollers (RM, RF, RI, RG) and the axis (AR) are horizontal. The rollers (RM, RF, RI, RG) are parallel to each other.

Furthermore, in accordance with the example provided above, the nip is formed by the rollers (RM) and (RF), where the roller (RM) is in a fixed position and the roller (RF) moves and is moved by the actuator (AT) to and from the roller (RM) to form the nip at a stage that precedes the production of the logs and remove the nip when the logs production is activated. It is understood that the mechanism for moving the movable roller (RF) may be different from the one described above, in which the arm (BF) is a connecting member that connects the actuator (AT) and the roller (RF).

A process for the production of paper logs according to the present invention comprises a step of supplying one or more paper plies (V1, V2) to a processing unit (EG; RW) that transforms the structure or the shape of the same plies and providing a guiding system for guiding the plies (V1, V2) along a predetermined path between one or more plies supplying stations (UN) and the processing unit (EG; RW), and it involves the step of moving the plies (V1, V2) through a nip which is temporarily formed in a step of drawing-in of the same plies towards the processing unit (EG, RW).

The drawing-in belt can be an elastic belt.

The drawing-in belt is used during the drawing-in step.

One of the rollers (RM, RF) forming said nip may have a length (measured transversely to the ply being treated, i.e. transversely to the aforementioned AV direction) less than the width of the ply intended to pass through the same nip. This feature can be applied to both rollers (RM, RF) each of which, in this case, will have a length (measured transversely to the ply being treated, i.e. transversely to the aforementioned AV direction) lower than the width of the ply passing through the nip. The width of the ply is measured transversely to the ply itself which by its nature has a predominantly longitudinal development.

For example, one of the rollers (RM, RF) can be coated with rubber, while the other one can be a smooth roller (for example, a steel roller), whose surface is not coated with any material increasing the friction coefficient of its outer surface.

For example, if more nips are provided along the path followed by the plies (V1, V2), each nip following the first nip can be provided at a distance of 10 m from the preceding one.

Although the invention has been described with respect to specific embodiments for a complete and clear disclosure, the appended claims are not to be thus limited but are to be construed as embodying all modifications and alternative constructions that may occur to anyone skilled in the art that fall within the basic teaching herein set forth.

1-18. (canceled)

19. Plant for the production of paper logs, comprising:
at least one unwinder that supports a reel from which a corresponding ply of paper unwounds, at least one processing unit that is supplied with said ply and is configured to modify the structure or conformation of the same ply, guiding means for guiding said ply arranged along a predetermined path between the at least one unwinder and the processing unit, characterized in that said guide means are configured to provide a nip traversed by said ply at a preliminary stage of drawing-in of the ply, said nip being subsequently eliminated when said step of drawing-in is completed.

20. Plant according to claim 19, wherein said processing unit is an embossing unit.

21. Plant according to claim 19, wherein said processing unit is a rewinder.

22. Plant according to claim 20, wherein the embossing unit supplies a rewinder.

23. Plant according to claim 19, wherein said nip is formed by a nip unit provided at a predetermined point of said path and comprising a motorized roller and an idle roller, the motorized roller being fixed in position at said point, the idle roller being connected to an actuator that allows to move it to and from the motorized roller.

24. Plant according to claim 23, wherein said idle roller is mounted on an arm adapted to rotate about a corresponding horizontal axis and connected to said actuator.

25. Process for the production of paper logs, comprising:
a step of supplying one or more paper plies to a processing unit that transforms the structure or conformation of the same plies and providing a guiding system for guiding the plies along a predetermined path between one or more plies supplying stations and the processing unit, further comprising a step of moving the plies through a nip which is temporarily formed in a step of drawing-in of the same plies towards the processing unit.

26. Process according to claim 25, wherein said processing unit is an embossing unit.

27. Process according to claim 25, wherein said processing unit is a rewinder.

28. Process according to claim 26, wherein the embossing unit supplies a rewinder.

29. Process according to claim 25, wherein said processing unit is an embossing unit that supplies a rewinder.

30. Process according to claim 25, wherein in said step of drawing-in, the plies are hooked to a drawing-in belt.

31. Process according to claim 30, wherein said drawing-in belt is elastic.

32. Process according to claim 25, wherein said nip is formed by a nip unit provided at a predetermined point of said path and comprising a motorized roller and an idle roller, the motorized roller being fixed in position at said point, the idle roller being connected to an actuator that allows to move it to and from the motorized roller.

33. Process according to claim 32, wherein at least one of said rollers is of length less than the width of the ply intended to pass through the nip, said length and said width being measured transversely to the ply.

34. Process according to claim 32, wherein one of said rollers is coated with a material which increases the coefficient of friction of its outer surface.

35. Process according to claim 32, wherein one of said rollers is a smooth roller.

36. Process according to claim 25, further comprising the passage of the plies through a plurality of said nips and each nip is arranged at a predetermined distance from the nip that precedes it along said predetermined path.
